(19) United States
(12) Patent Application Publication
(10) Pub. No.: US 2024/0123773 A1
(43) Pub. Date: Apr. 18, 2024

(54) TIRE HAVING A NOVEL CONDUCTIVE PATHWAY

(71) Applicant: COMPAGNIE GENERALE DES ETABLISSEMENTS MICHELIN, Clermont-Ferrand (FR)

(72) Inventors: CLAUDE ORLOWSKI, Clermont-Ferrand (FR); STEPHANE QUENARD, Clermont-Ferrand (FR)

(21) Appl. No.: 18/276,337

(22) PCT Filed: Jan. 27, 2022
(86) PCT No.: PCT/FR2022/050152

§ 371 Date: Aug. 8, 2023

(30) Foreign Application Priority Data
Feb. 8, 2021 (FR) FR2101165

(51) Int. Cl. B60C 19/08; B60C 9/20

(52) U.S. Cl. CPC B60C 19/082; B60C 9/2009

(57) ABSTRACT

A tire comprises a working reinforcement (16) comprising at least one working layer and a hoop reinforcement (17) arranged radially outside the working reinforcement (16). The tire (10) comprises an electrically conductive element (80) arranged so as to ensure electrical conductivity between a mounting support for the tire (10) and the crown (12) by means of the conductive element (80), the crown (12) being arranged so as to ensure electrical conductivity from the electrically conductive element (80) to the tread surface (13) radially through or by means of the hoop reinforcement (17) and by means of the tread (20). At least one so-called interposed portion (801) of the electrically conductive element (80) is arranged radially between the working layer (18) and the hoop reinforcement (17).

The present invention relates to a tyre.

A tyre comprising a crown, two sidewalls and two beads, each sidewall connecting each bead to the crown, is known from the prior art, in particular from EP1526005.

The tyre also comprises a carcass reinforcement anchored in each bead and extending in each sidewall and in the crown.

The crown comprises a tread suitable for coming into contact with the ground when the tyre is running, and a crown reinforcement arranged radially between the tread and the carcass reinforcement, which extends radially inside the crown reinforcement. The crown reinforcement and the tread are arranged in contact with each other.

The crown reinforcement comprises a working reinforcement comprising a radially innermost layer and a radially outermost layer arranged radially outside the radially innermost layer. The crown reinforcement also comprises a hoop reinforcement arranged radially outside the working reinforcement and comprising a hoop layer.

The tyre described in EP1526005 also comprises an electrically conductive element arranged so as to ensure electrical conductivity between a mounting support when the tyre is mounted on the mounting support and the crown radially through at least one of the sidewalls by means of the electrically conductive element. Such a mounting support comprises an electrically conductive metal rim. More specifically, the electrically conductive element of the tyre in EP1526005 is arranged so as to ensure electrical conductivity from a mass of an electrically conductive material suitable for being in contact with the mounting support when the tyre is mounted on the mounting support to the radially innermost working layer through at least one of the sidewalls by means of the electrically conductive element.

In addition, the crown of the tyre in EP1526005 is arranged so as to ensure electrical conductivity from the electrically conductive element to the tread surface by means of the two working layers, the hoop layer, a sublayer and a tread layer of the tread.

However, tyre manufacturers are constantly seeking to reduce the rolling resistance of tyres for environmental reasons. One of the numerous solutions for reducing this rolling resistance consists of reducing the hysteresis of the tyre crown. A significant reduction can be obtained by reducing the hysteresis of the tread and of the crown reinforcement.

The reduction in the hysteresis of the tread and of the crown reinforcement is in particular obtained by using crown layers, in particular working layers, comprising filamentary reinforcing elements embedded in low-hysteresis materials based on fillers comprising silica as the predominant filler. While such low-hysteresis materials significantly reduce hysteresis, they are generally electrically insulating compared with electrically conductive materials based on fillers comprising carbon black as the predominant filler.

Reducing the rolling resistance of the tyre through the use of an electrically insulating crown reinforcement, in particular an electrically insulating working reinforcement, thus does not ensure satisfactory discharge of the electrical charge from the vehicle to the ground being driven on by means of the tyre.

Other tyres make it possible to discharge the electrical charge while avoiding the working reinforcement, not by means of the hoop layer, but through the hoop reinforcement. Such tyres are described in the JP2010159017. The tyre in JP2010159017 comprises an additional conductive element arranged so as to ensure electrical conductivity between the electrically conductive element and the hoop reinforcement. The additional conductive element takes the form of a strip wound around one of the axial ends of the radially innermost working layer, which makes it possible to form a conductive pathway that does not pass by means of the working layers. However, such a solution is relatively complex due to the need to arrange the additional conductive element around one of the axial ends of the radially innermost working layer.

The invention aims to allow the use of electrically insulating materials in at least the working reinforcement while simply allowing satisfactory discharge of the electrical charge from the vehicle to the ground being driven on by means of the tyre.

To this end, the invention relates to a tyre suitable for being mounted on a mounting support and comprising a crown, two beads, two sidewalls each connecting each bead to the crown, and a carcass reinforcement anchored in each bead, the crown comprising a tread comprising a tread surface suitable for coming into contact with the ground being driven on, and a crown reinforcement, the carcass reinforcement extending in each sidewall and in the crown radially inside the crown reinforcement, the crown reinforcement being arranged radially between the tread and the carcass reinforcement and comprising:
a working reinforcement comprising at least one radially outermost working layer of the working reinforcement,
a hoop reinforcement arranged radially outside the working reinforcement,
   the tyre comprising an electrically conductive element arranged so as to ensure electrical conductivity between a mounting support when the tyre is mounted on the mounting support and the crown by means of the conductive element,
   the crown being arranged so as to ensure electrical conductivity from the electrically conductive element to the tread surface radially through or by means of the hoop reinforcement and by means of the tread,
   at least one so-called interposed portion of the electrically conductive element being arranged radially between the radially outermost working layer of the working reinforcement and the hoop reinforcement,
   as the electrically conductive element extends radially inside the equatorial circumferential plane of the tyre, the electrically conductive element is radially continuous between:
any point of the electrically conductive element situated radially inside the equatorial circumferential plane of the tyre, and
any point of the electrically conductive element situated radially between the radially outermost working layer of the working reinforcement and the hoop reinforcement.

Due to the radial positioning of the interposed portion between the radially outermost layer of the working reinforcement and the hoop reinforcement, if desired, electrically insulating materials can be used in the working reinforcement, which no longer has to form, by means thereof, part of the electrically conductive pathway between the electrically conductive element and the tread surface.

In addition, the absence of an additional conductive element wound around one of the axial ends of the radially innermost working layer makes the tyre much simpler to manufacture.

In addition, according to the invention, the electrically conductive pathway passes radially through the hoop reinforcement or by means of the hoop reinforcement. There is thus no need to provide an electrically conductive pathway avoiding the crown reinforcement, and in particular avoiding the hoop reinforcement, as described for example in EP1621365 or US20050103412. A conductive pathway avoiding the hoop reinforcement requires the use of a tread comprising at least one mass of a material arranged in contact with the electrically conductive element so as to ensure electrical conductivity between the electrically conductive element and the tread surface without passing through or by means of the hoop reinforcement, which limits or even prohibits the use of low-hysteresis materials in the tread.

Radially continuous is given to mean that there are no joints, for example by abutment or superposition, between a plurality of separate portions of the conductive element. This thus avoids the incorporation of a plurality of separate portions the joint interfaces of which would have to be controlled so as to ensure the continuity of the electrically conductive pathway between the points described above.

The tyre according to the invention has electrical resistance of less than or equal to 10¹⁰ ohms and preferably less than or equal to 10⁸ ohms, the electrical resistance being measured in accordance with ISO 16392:2017.

As is conventional for a person skilled in the art, reinforcement is given to mean one or more layers of a matrix, preferably elastomeric, in which are embedded one or more reinforcing elements, preferably one or more filamentary reinforcing elements, suitable for reinforcing the matrix of the or each layer.

In the present application, an element is arranged so as to ensure electrical conductivity from a first member to a second member when it forms a conductive pathway extending from the first member to the second member. The element is thus arranged in contact with the first member and the second member.

In the present application, an element is arranged so as to ensure electrical conductivity between a first member and a second member when it forms a conductive pathway extending between the first member and the second member without necessarily extending from the first member to the second member. The element can thus form all or part of the conductive pathway extending from the first member to the second member.

In the present application, an element arranged so as to prevent electrical conductivity by means of this element means that the conductive pathway does not pass through the element. Conversely, an element arranged so as to ensure electrical conductivity by means of this element means that the conductive pathway passes through this element.

When electrical conductivity is ensured by means of an element radially through a member, this means that the conductive pathway takes place by means of the element that physically passes through the member.

In the context of the invention, an element arranged so as to prevent electrical conductivity or an insulating material of such an element is such that the element does not form part of the conductive pathway between the mounting support and the tread surface when the tyre is mounted on the mounting support.

In the context of the invention, an element arranged so as to ensure electrical conductivity or an electrically conductive material of such an element is such that the element forms part of the conductive pathway between the mounting support and the tread surface when the tyre is mounted on the mounting support.

Predominant filler in a material is given to mean that this filler is predominant among the fillers in the material, that is, it is the filler representing the greatest quantity by weight among the fillers. The expression “material based on” should be understood as meaning a material including the mixture and/or the product of the in situ reaction of the various constituents used, wherein some of these constituents can react and/or are suitable for reacting with each other, at least partially, during the various phases of manufacturing the material; the material can thus be in the totally or partially crosslinked state or in the non-crosslinked state.

The tyres of the invention are preferably suitable for passenger vehicles as defined according to the European Tyre and Rim Technical Organisation, or “ETRTO”, standard of 2020. Such a tyre has a section in a meridian section plane characterized by a section height H and a nominal section width S, according to the European Tyre and Rim Technical Organisation, or “ETRTO”, standard of 2020, such that, very advantageously and for most tyres, the ratio H/S, expressed as a percentage, is at most equal to 90, preferably at most equal to 80 and more preferably at most equal to 70, and is at least equal to 30, preferably at least equal to 40, and the nominal section width S is, very advantageously and for most tyres, at least equal to 115 mm, preferably at least equal to 155 mm and more preferably at least equal to 175 mm, and at most equal to 385 mm, preferably at most equal to 315 mm, more preferably at most equal to 285 mm and even more preferably at most equal to 255 mm. In addition, the diameter D at the rim flange, which defines the diameter of the mounting rim of the tyre, is, very advantageously and for most tyres, at least equal to 12 inches, preferably at least equal to 16 inches, and at most equal to 24 inches, preferably at most equal to 20 inches.

Axial direction is given to mean the direction substantially parallel to the main axis of the tyre or of the main manufacturing support, that is, the axis of rotation of the tyre or of the main manufacturing support.

Circumferential direction is given to mean the direction that is substantially perpendicular both to the axial direction and to a radius of the tyre or of the main manufacturing support (in other words, tangent to a circle centred on the axis of rotation of the tyre or of the main manufacturing support).

Radial direction is given to mean the direction along a radius of the tyre or of the main manufacturing support, that is, any direction that intersects the axis of rotation of the tyre or of the main manufacturing support and is substantially perpendicular to that axis.

Mid-plane of the tyre (denoted M) is given to mean the plane perpendicular to the axis of rotation of the tyre, which is situated axially halfway between the two beads and passes through the axial middle of the crown reinforcement.

Equatorial circumferential plane of the tyre (denoted E) is given to mean the theoretical cylindrical surface passing through the equator of the tyre, perpendicular to the mid-plane and to the radial direction. The equator of the tyre is, in a meridian section plane (plane perpendicular to the circumferential direction and parallel to the radial and axial directions), the axis parallel to the axis of rotation of the tyre and situated equidistantly between the radially outermost point of the tread suitable for being in contact with the ground and the radially innermost point of the tyre suitable for being in contact with a support, for example a rim, the distance between these two points being equal to H.

Meridian plane is given to mean a plane parallel to and containing the axis of rotation of the tyre and perpendicular to the circumferential direction.

Bead is given to mean the portion of the tyre suitable for allowing the tyre to be attached to a mounting support, for example a wheel comprising a rim. Each bead is thus in particular suitable for being in contact with a flange of the rim allowing it to be attached.

Main direction in which a filamentary reinforcing element extends is understood to be the direction in which the filamentary reinforcing element extends along its greatest length. The main direction in which a filamentary reinforcing element extends can be straight or curved, and the reinforcing element can describe a straight or undulating path in its main direction.

Any range of values denoted by the expression “between a and b” represents the range of values extending from more than a to less than b (that is, excluding the end-points a and b), whereas any range of values denoted by the expression “from a to b” means the range of values extending from a to b (that is, including the strict end-points a and b).

In the tyre, the angle taken into consideration is the angle, as an absolute value, which is the smaller of the two angles defined between the reference straight line, here the circumferential direction of the tyre, and the main direction in which the filamentary reinforcing element under consideration extends.

In the tyre and in the method, orientation of an angle is given to mean the direction, clockwise or anti-clockwise, in which it is necessary to turn from the reference straight line, here the circumferential direction of the support or of the tyre, which defines the angle in order to reach the main direction in which the filamentary reinforcing element under consideration extends.

In the method, the angles taken into consideration formed by the main directions in which the working and carcass filamentary reinforcing elements extend are, by convention, angles with opposite orientations, and the angle formed by the main direction in which each working filamentary reinforcing element extends is, as an absolute value, the smaller of the two angles defined between the reference straight line, here the circumferential direction of the support or of the tyre, and the main direction in which the working filamentary reinforcing element extends. The angle formed by the main direction in which each working filamentary reinforcing element extends thus defines an orientation which is opposite to that formed by the angle of the main direction in which each carcass filamentary reinforcing element extends.

In the tyre according to the invention, the crown comprises the tread and the crown reinforcement. Tread is given to mean a strip of polymeric, preferably elastomeric, material delimited:
radially outwards, by the tread surface and
radially inwards, by the crown reinforcement,
axially, by two planes perpendicular to the axial direction and passing through the axial ends of the tread surface.

Conventionally, the tread surface is determined on a tyre mounted on a nominal rim and inflated to nominal pressure according to the European Tyre and Rim Technical Organisation, or “ETRTO”, 2020 standard. If there is an obvious boundary between the tread surface and the rest of the tyre, the axial ends and axial width of the tread surface are simply determined. If the tread surface is continuous with the outer surfaces of the sidewalls of the tyre, the axial ends of the tread surface are, in a meridian section plane, coincident with the point at which the angle between the tangent to the tread surface and a straight line parallel to the axial direction passing through this point is equal to 30°. When, in a meridian section plane, there are several points at which said angle is equal, as an absolute value, to 30°, the radially outermost point is used.

The strip of polymeric material is made up of a layer of preferably polymeric and more preferably elastomeric material or comprises a plurality of layers, each layer preferably being made up of a polymeric and more preferably elastomeric material.

In one advantageous embodiment, the crown reinforcement comprises a single hoop reinforcement and a single working reinforcement. Thus, apart from the hoop reinforcement and the working reinforcement, the crown reinforcement does not have any reinforcement reinforced by filamentary reinforcing elements. The filamentary reinforcing elements of such reinforcements excluded from the crown reinforcement of the tyre comprise metal filamentary reinforcing elements and textile filamentary reinforcing elements. Very preferably, the crown reinforcement is made up of the hoop reinforcement and the working reinforcement.

In one very preferable embodiment, apart from the crown reinforcement, the crown does not have any reinforcement reinforced by filamentary reinforcing elements. The filamentary reinforcing elements of such reinforcements excluded from the crown of the tyre comprise metal filamentary reinforcing elements and textile filamentary reinforcing elements. Very preferably, the crown is made up of the tread and the crown reinforcement.

In one very preferable embodiment, the carcass reinforcement is arranged directly radially in contact with the crown reinforcement and the crown reinforcement is arranged directly radially in contact with the tread.

The invention can advantageously be used in one embodiment in which the working reinforcement is arranged so as to prevent electrical conductivity by means of the working reinforcement.

As explained above, a working reinforcement can thus advantageously be used comprising low-hysteresis materials based on one or more fillers comprising silica as the predominant filler.

In a preferable configuration of the working reinforcement, the or each working layer comprises working filamentary reinforcing elements embedded in an electrically insulating material.

Such working filamentary reinforcing elements are preferably metal. However, polymeric or mineral filamentary reinforcing elements can be envisaged, that is, comprising one or more polymeric or mineral monofilaments. Each polymeric monofilament is preferably selected from aliphatic polyamide, aromatic polyamide and polyester monofilaments. Each mineral monofilament is preferably selected from carbon or glass monofilaments.

Advantageously, as the or each working layer is axially delimited by two axial edges of the working layer, the working filamentary reinforcing elements extend axially from one axial edge to the other axial edge of the working layer, substantially parallel to each other.

In a particularly advantageous variant, the working reinforcement comprises a single working layer. In this variant, the radially outermost working layer is therefore the single working layer. The presence of a single working layer makes it possible in particular to make the tyre lighter, and therefore reduce the energy dissipated by hysteresis of the crown, and therefore reduce the rolling resistance of the tyre. Thus, the working reinforcement does not, apart from the working layer, have any layer reinforced by filamentary reinforcing elements. The filamentary reinforcing elements of such reinforced layers excluded from the working reinforcement of the tyre comprise metal filamentary reinforcing elements and textile filamentary reinforcing elements. Very preferably, the working reinforcement is made up of the single working layer.

In another variant, the working reinforcement comprises a radially innermost layer and a radially outermost layer arranged radially outside the radially innermost layer. In this variant, the main direction in which each working filamentary reinforcing element of the radially innermost working layer extends and the main direction in which each working filamentary reinforcing element of the radially outermost working layer extends form, with the circumferential direction of the tyre, angles of opposite orientations.

Regardless of the variant, each working filamentary reinforcing element extends in a main direction forming an angle which, as an absolute value, is strictly greater than 10°, preferably ranging from 15° to 50°, with the circumferential direction of the tyre.

In a first embodiment of the invention, the hoop reinforcement is arranged so as to ensure electrical conductivity from the interposed portion of the electrically conductive element to the tread by means of the hoop reinforcement.

According to this first embodiment, the hoop reinforcement is in contact with the electrically conductive element and in contact with the tread so as to form the conductive pathway electrically connecting the electrically conductive element and the tread to each other.

In a preferable configuration of the first embodiment of the hoop reinforcement, the hoop reinforcement comprises one or more hoop filamentary reinforcing elements embedded in an electrically conductive material.

Preferably, such hoop filamentary reinforcing elements are polymeric or mineral filamentary reinforcing elements as described above with reference to the working filamentary reinforcing elements.

In a first variant of the first embodiment, the tread comprises one or more masses of one or more electrically conductive materials, the or each mass of the electrically conductive material(s) being arranged so as to ensure electrical conductivity from the hoop reinforcement to the tread surface by means of the or each mass.

According to this first variant, the tread is in contact with the hoop reinforcement so as to form the conductive pathway electrically connecting the hoop reinforcement and the tread surface to each other.

In a second variant of the first embodiment allowing the use of a tread comprising electrically insulating and, for example, low-hysteresis materials, the tread comprises one or more masses of one or more electrically insulating materials and at least one mass of at least one electrically conductive material arranged so as to ensure electrical conductivity from the hoop reinforcement to the tread surface by means of the mass of the electrically conductive material radially through the mass(es) of the electrically insulating material(s).

According to this second variant, the mass of the electrically conductive material is in contact with the hoop reinforcement and in contact with the tread surface so as to form the conductive pathway electrically connecting the hoop reinforcement and the tread surface to each other.

So as to reduce the hysteresis of the tread as much as possible, the volume of the mass(es) of electrically insulating materials is greater than or equal to 50%, preferably greater than or equal to 75%, and more preferably greater than or equal to 95% of the volume of the tread.

In a second embodiment of the invention, the hoop reinforcement is arranged so as to prevent electrical conductivity from the interposed portion of the electrically conductive element to the tread by means of the hoop reinforcement.

In a preferable configuration of the second embodiment of the hoop reinforcement, the hoop reinforcement comprises one or more hoop filamentary reinforcing elements embedded in an electrically insulating elastomeric material.

Very preferably in the second embodiment, the crown comprises an additional mass of an electrically conductive material arranged so as to ensure electrical conductivity from the interposed portion of the electrically conductive element to the tread radially through the hoop reinforcement by means of the additional mass of the electrically conductive material.

According to this first variant, the additional mass is in contact with the electrically conductive element and in contact with the tread so as to form the conductive pathway electrically connecting the electrically conductive element and the tread to each other. Of course, a plurality of additional masses of one or more electrically conductive materials each forming part of the electrically conductive pathway passing radially through the hoop reinforcement can be used.

Preferably, the additional mass is arranged radially between the tread and the interposed portion of the electrically conductive element and arranged axially between first and second axial portions of the hoop reinforcement. The additional mass can thus be positioned between the first and second axial portions the axial widths of which will be determined as a function of the desired performance of the hoop reinforcement.

In a first variant, as the hoop reinforcement is axially delimited by two axial edges of the hoop reinforcement, the hoop reinforcement comprises a single strip wound circumferentially in a helix so as to extend axially continuously from one of the axial edges of the hoop reinforcement to the other of the edges of the hoop reinforcement.

In this first variant, the strip is thus continuous between the first and second axial portions of the hoop reinforcement, which are connected to each other by a portion of the strip. The manufacturing method is relatively simple as it comprises a step of continuously winding the strip to form the hoop reinforcement.

In a second variant, as the hoop reinforcement is axially delimited by two axial edges of the hoop reinforcement, the first and second axial portions are axially separate from each other so that:
the first axial portion comprises a first strip wound circumferentially in a helix so as to extend axially continuously from one of the axial edges of the hoop reinforcement to an axially inner edge of the first axial portion, and
the second axial portion comprises a second strip wound circumferentially in a helix so as to extend axially continuously from an inner axial edge of the second axial portion to the other of the axial edges of the hoop reinforcement.

Whether in the first or second variant, the additional mass can easily be positioned in a portion situated axially between the first and second portions.

In a first variant of the second embodiment, the tread comprises one or more masses of one or more electrically conductive materials, the or each mass of electrically conductive material being arranged so as to ensure electrical conductivity from the additional mass of electrically conductive material to the tread by means of the or each mass. According to this second variant, the tread is in contact with the additional mass so as to form the conductive pathway electrically connecting the additional mass and the tread surface to each other.

In a second variant of the second embodiment allowing the use of a tread comprising electrically insulating and, for example, low-hysteresis materials, the tread comprises one or more masses of one or more electrically insulating materials and at least one mass of at least one electrically conductive material arranged so as to ensure electrical conductivity from the additional mass of the electrically conductive material to the tread surface by means of the mass of the electrically conductive material radially through the mass(es) of the electrically insulating material(s). According to this second variant, the mass of the electrically conductive material is in contact with the additional mass and in contact with the tread surface so as to form the conductive pathway electrically connecting the additional mass and the tread surface to each other.

Preferably, the electrically conductive element comprises a layer made up of an electrically conductive material. The layer can extend circumferentially over a length corresponding to an angle less than or equal to 360°. More preferably, the layer extends circumferentially over a length corresponding to an angle less than or equal to 90° so as to limit the mass of the electrically conductive element. In one variant, the electrically conductive material of the layer is an elastomeric material. In another variant, the electrically conductive material of the layer is an electrically conductive ink. In yet another variant, the electrically conductive element comprises an electrically conductive filamentary element, for example a monofilament or an assembly of monofilaments.

In some embodiments, the tyre comprises a plurality of separate conductive elements distributed evenly or unevenly on the circumference of the tyre, regardless of the variant of electrically conductive element described above.

Regardless of the embodiment and variant, the hoop reinforcement is optionally delimited axially by two axial edges of the hoop reinforcement and comprises at least one hoop filamentary reinforcing element wound circumferentially in a helix so as to extend axially between the axial edges of the hoop reinforcement.

Whether in the first or second embodiment, the or each hoop filamentary reinforcing element optionally extends in a main direction forming an angle which, as an absolute value, is less than or equal than 10°, preferably less than or equal to 7°, and more preferably less than or equal to 5°, with the circumferential direction of the tyre.

In a first configuration of the electrically conductive element, the electrically conductive element comprises first and second axial ends and extends axially from a first of the beads into the second of the beads, passing radially between the radially outermost working layer and the hoop reinforcement so that each first and second axial end is in contact:
with first and second masses of electrically conductive material of each first and second bead respectively, each first and second mass of electrically conductive material being in contact with the mounting support when the tyre is mounted on the mounting support, or
with the mounting support when the tyre is mounted on the mounting support.

In this first configuration, the electrically conductive element physically connects the first and second beads to each other.

If each first and second axial end is in contact with each first and second mass of electrically conductive material, the conductive pathway passes through each first and second mass of electrically conductive material, then through the electrically conductive element.

If each first and second axial end is in contact with the mounting support when the tyre is mounted on the mounting support, this avoids the need for beads comprising masses of electrically conductive material. Beads can thus be used comprising materials suitable for being in contact with the mounting support that are electrically insulating and, for example, have low hysteresis.

In a second configuration of the electrically conductive element, the electrically conductive element comprises first and second axial ends and extends axially from a first of the beads to radially between the radially outermost working layer and the hoop reinforcement so that:
the first axial end is in contact with a mass of an electrically conductive material of one of the first and second beads, this electrically conductive material being in contact with the mounting support when the tyre is mounted on the mounting support, and the second axial end is arranged radially between the radially outermost working layer and the hoop reinforcement, or
the first axial end is in contact with the mounting support when the tyre is mounted on the mounting support, and the second axial end is arranged radially between the radially outermost working layer and the hoop reinforcement.

Unlike in the first configuration, the electrically conductive element of this second configuration does not physically connect the first and second beads to each other, which makes it possible to reduce the quantity of electrically conductive element used. A variant can be envisaged in which only one of the first and second beads is physically connected to the crown reinforcement by means of the electrically conductive element, and a variant in which each first and second bead is mechanically connected to the crown reinforcement by means of two separate conductive elements.

Similarly to the first configuration, if the first axial end is in contact with the mass of electrically conductive material, the conductive pathway passes through the mass of electrically conductive material, then through the electrically conductive element.

Similarly to the first configuration, if the first axial end is in contact with the mounting support when the tyre is mounted on the mounting support, this avoids the need for a bead comprising a mass of electrically conductive material. Beads can thus be used comprising materials suitable for being in contact with the mounting support that are electrically insulating and, for example, have low hysteresis.

In one variant of the carcass reinforcement, the carcass reinforcement comprises a single carcass layer. In this variant, apart from the single carcass layer, the carcass reinforcement does not have any layer reinforced by filamentary reinforcing elements. The filamentary reinforcing elements of such reinforced layers excluded from the carcass reinforcement of the tyre comprise metal filamentary reinforcing elements and textile filamentary reinforcing elements. Very preferably, the carcass reinforcement is made up of the single carcass layer.

In another variant, the carcass reinforcement comprises two carcass layers. In this variant, the main directions of the carcass filamentary reinforcing elements of the two carcass layers are preferably substantially parallel to each other.

Advantageously, the carcass reinforcement comprises at least one carcass layer, the or each carcass layer being delimited axially by two axial edges of the or each carcass layer, and comprises carcass filamentary reinforcing elements extending axially from one axial edge to the other axial edge of the or each carcass layer.

In an embodiment using one or more radial carcass layers, each carcass filamentary reinforcing element extends in a main direction of each carcass filamentary reinforcing element that forms, as an absolute value, a substantially constant angle between each axial edge of the or each carcass layer ranging from 80° to 90°, with the circumferential direction of the tyre.

In one particular embodiment of a tyre in which the working reinforcement comprises a single working layer, each carcass filamentary reinforcing element extends in a main direction of each carcass filamentary reinforcing element that forms, with the circumferential direction of the tyre:
an angle, as an absolute value, strictly less than 80°, in an axially central portion of the carcass layer extending axially in radial line with the working layer,
an angle, as an absolute value, ranging from 80° to 90°, in two axially lateral portions of the carcass layer extending axially radially between the axially central portion and each axial edge of the carcass layer.

This particular embodiment is advantageous as it makes it possible, in the method for manufacturing the tyre, to easily incorporate the electrically conductive element when the assembly being formed still has a substantially cylindrical shape about the main axis of the main manufacturing support.

During such a method:
at least one carcass assembly suitable for forming the carcass reinforcement is arranged around a main support having a substantially cylindrical shape about a main axis,
at least one working assembly suitable for forming the working reinforcement is arranged radially outside the carcass assembly, the carcass assembly and the working assembly forming an assembly having a substantially cylindrical shape about the main axis of the main support,
the assembly having a substantially cylindrical shape about the main axis of the main support is deformed so as to obtain an assembly having a substantially toric shape about the main axis of the main support,
after the deformation step, at least one hoop assembly suitable for forming the hoop reinforcement is arranged radially outside the assembly having a substantially toric shape about the main axis of the main support,
prior to the step of deforming the assembly, the electrically conductive element is arranged radially outside the working assembly so that, after the step of arranging the hoop assembly, at least one so-called interposed portion of the electrically conductive element is arranged radially between the working assembly and the hoop assembly.

Whether for the hoop reinforcement, the working layer(s), or the carcass layer(s), the materials in which the filamentary reinforcing elements are embedded are preferably elastomeric. Elastomeric is given to mean a material that exhibits elastomeric behaviour in the crosslinked state. Such a material is advantageously obtained by crosslinking a composition comprising at least one elastomer and at least one other component. Preferably, the composition comprising at least one elastomer and at least one other component comprises an elastomer, a crosslinking system and a filler. The compositions used for these layers are conventional compositions for skim coating reinforcers, typically based on natural rubber or another diene elastomer, a reinforcing filler, a vulcanization system and conventional additives. The adhesion between the filamentary reinforcing elements and the matrix in which they are embedded is ensured for example by a conventional adhesive composition, for example an RFL adhesive or an equivalent adhesive.

### DESCRIPTION OF THE EXAMPLES

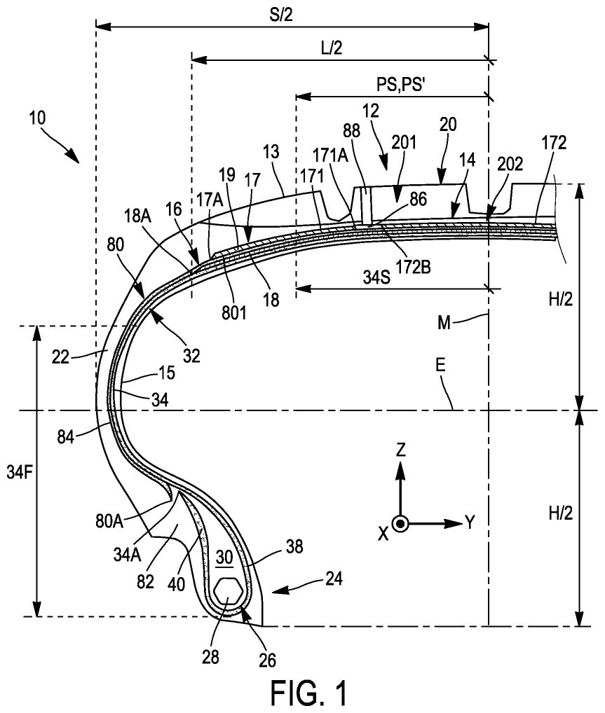

The invention and its advantages will be easily understood in the light of the detailed description and the non-limiting exemplary embodiments which follow, and from FIGS. 1 to 22, which relate to these examples and in which:

FIG. 1 is a cross-sectional view in a meridian section plane of a tyre according to a first embodiment of the invention,

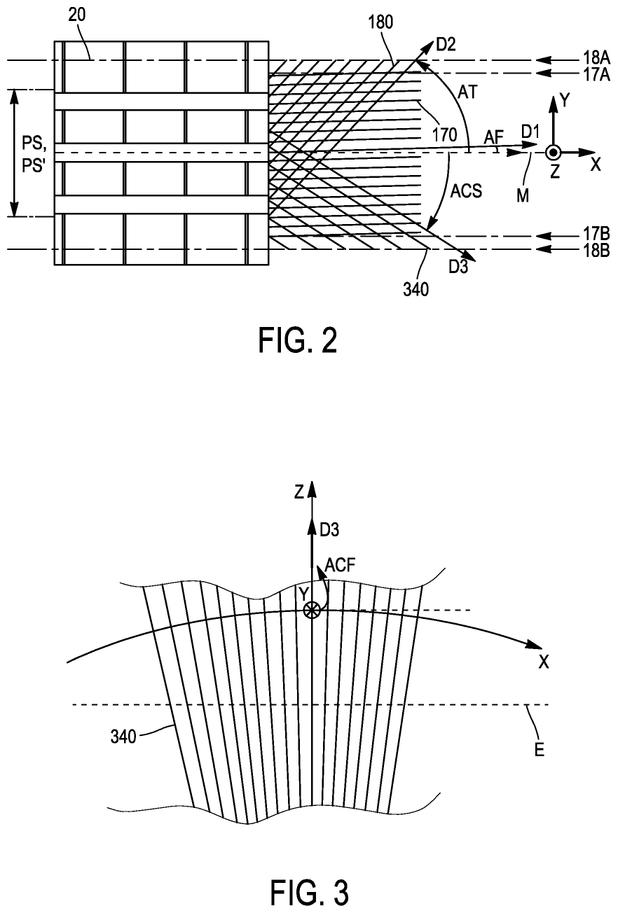

FIG. 2 is a schematic cutaway view of the tyre in FIG. 1, illustrating the arrangement of the filamentary reinforcing elements in the crown,

FIG. 3 is a schematic view of the carcass filamentary reinforcing elements arranged in the sidewall of the tyre in FIG. 1,

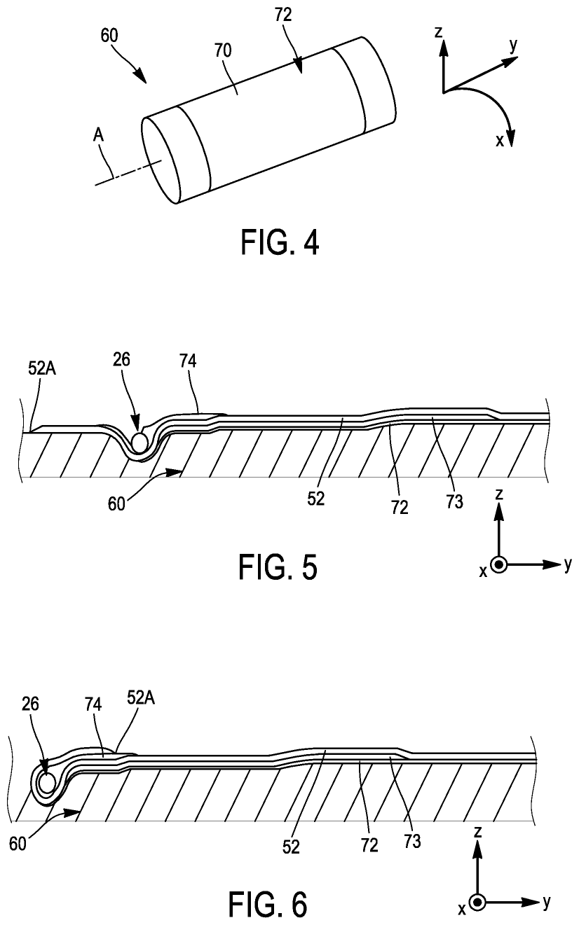

FIGS. 4 to 16 illustrate the different steps of the method for manufacturing the tyre in FIG. 1,

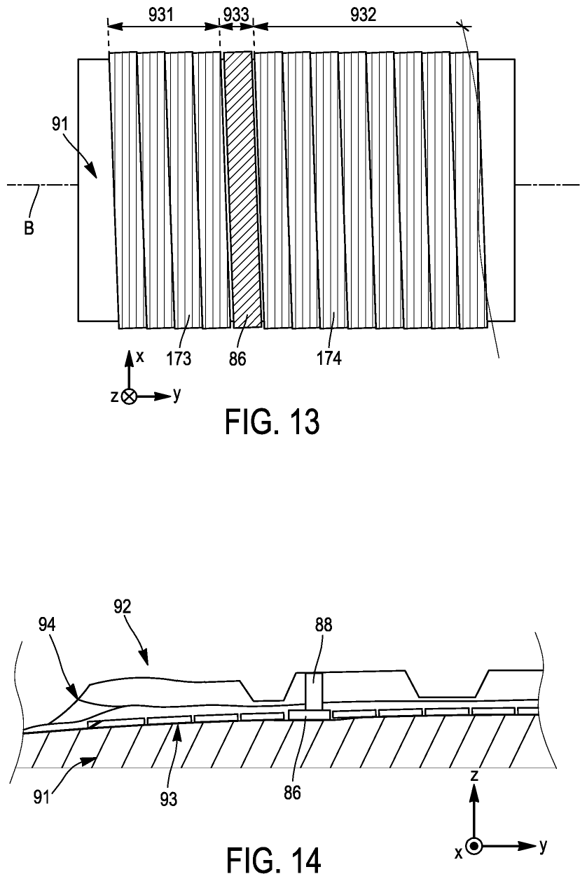

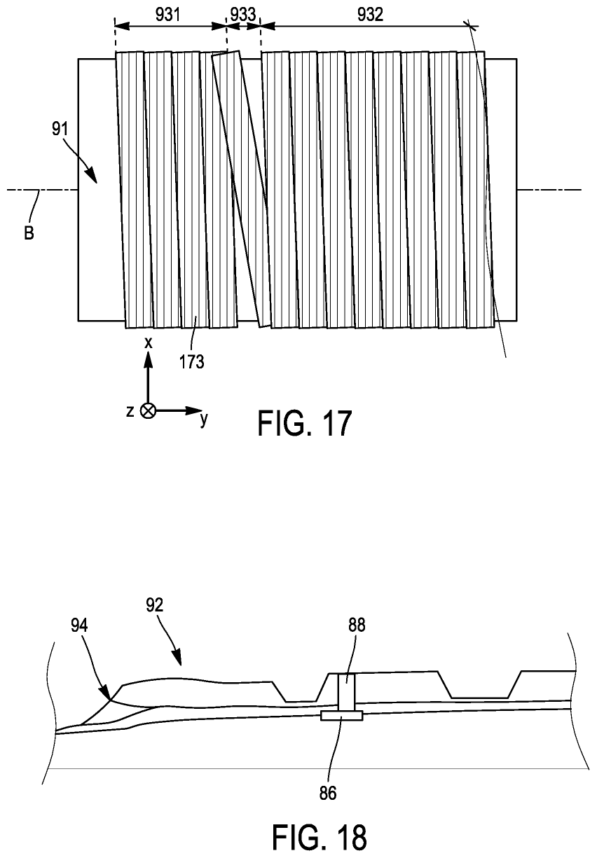

FIGS. 17 and 18 illustrate steps of a method according to a second embodiment and are similar to FIGS. 13 and 14, and

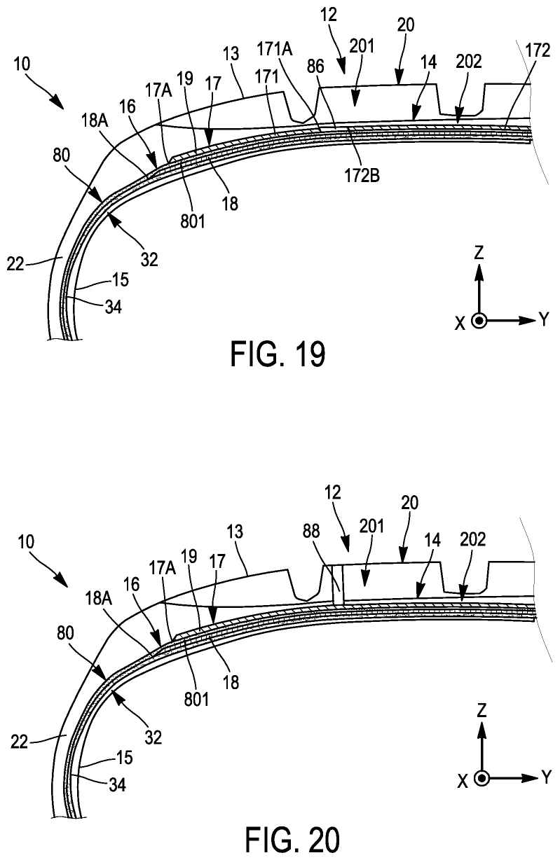

FIGS. 19 to 22 are views similar to the one in FIG. 1 of tyres according to second, third, fourth, fifth and sixth embodiments respectively.

A frame of reference X, Y, Z corresponding respectively to the usual circumferential (X), axial (Y) and radial (Z) directions of a tyre is shown in the figures relating to the tyre. A frame of reference x, y, z corresponding respectively to the usual circumferential (x), axial (y) and radial (z) directions of a main manufacturing support that is deformable between a substantially cylindrical shape and a toric shape about the axis y is shown in the figures relating to the method.

FIG. 1 shows a tyre according to the invention and denoted by the general reference sign 10. The tyre 10 substantially exhibits symmetry of revolution about an axis substantially parallel to the axial direction Y. Here, the tyre 10 is suitable for a passenger vehicle and has dimensions 245/45R18. The tyre 10 is suitable for being mounted on a mounting support, for example a rim.

The tyre 10 comprises a crown 12 comprising a tread 20 comprising a tread surface 13 suitable for coming into contact with the ground being driven on and a crown reinforcement 14 extending in the crown 12 in the circumferential direction X. The crown reinforcement 14 and the tread 20 are arranged in contact with each other. The tyre 10 also comprises a sealing layer 15 for sealing against an inflation gas, suitable for defining a closed internal cavity with a mounting support for the tyre 10 once the tyre 10 has been mounted on the mounting support, for example an electrically conductive metal rim.

The tread 20 comprises one or more masses of one or more electrically insulating materials. In this particular instance, the tread 20 comprises a first mass 201 of a first electrically insulating material forming a running layer and a second mass 202 of a second electrically insulating material forming a backing layer for the running layer. The backing layer 202, also called a sublayer, is arranged radially inside the running layer 201. Each first and second electrically insulating material is an electrically insulating elastomeric material, for example based on compositions as described in US20180066128, FR3059598 or U.S. Pat. No. 6,289,958.

The crown reinforcement 14 comprises a single working reinforcement 16 comprising at least one radially outermost working layer 18 of the working reinforcement 16 and a single hoop reinforcement 17 comprising a single hoop layer 19. Here, the working reinforcement 16 comprises a single working layer 18 and, in this particular instance, is made up of the single working layer 18. In the following description, for reasons of simplification, the working layer 18 will be mentioned without restating each time that this is a single layer. The hoop reinforcement 17 is made up of the hoop layer 19.

The crown reinforcement 14 is surmounted radially by the tread 20. Here, the hoop reinforcement 17, here the hoop layer 19, is arranged radially outside the working reinforcement 16 and is therefore interposed radially between the working reinforcement 16 and the tread 20. In the embodiment illustrated in FIGS. 1 and 2, the hoop reinforcement 17 has an axial width smaller than the axial width of the working layer 18. The hoop reinforcement 17 is thus axially the narrower of the working layer 18 and the hoop reinforcement 17.

The tyre 10 comprises two sidewalls 22 that extend the crown 12 radially inwards. The tyre 10 also has two beads 24 radially inside the sidewalls 22. Each sidewall 22 respectively connects each bead 24 to the crown 12.

Each bead 24 comprises at least one circumferential reinforcing element 26, in this instance a bead wire 28 surmounted radially by a filling mass 30.

The tyre 10 comprises a carcass reinforcement 32 anchored in each bead 24. The carcass reinforcement 32 extends radially in each sidewall 22 and in the crown 12, radially inside the crown reinforcement 14. The crown reinforcement 14 is arranged radially between the tread 20 and the carcass reinforcement 32.

The carcass reinforcement 32 comprises a carcass layer 34. Here, the carcass reinforcement 32 comprises a single carcass layer 34, and in this particular instance consists of the single carcass layer 34. In this embodiment, for reasons of simplification, the carcass layer 34 will be mentioned without restating each time that this is a single layer.

The carcass reinforcement 32 is arranged directly radially in contact with the crown reinforcement 14. The crown reinforcement 14 is arranged directly radially in contact with the tread 20. The hoop reinforcement 17 and the working layer 18 are arranged directly radially in contact with each other.

The hoop layers 19, the working layer 18 and the carcass layer 34 will now be described with reference to FIGS. 1 to 3.

The hoop reinforcement 17, here the hoop layer 19, is delimited axially by two axial edges 17A, 17B of the hoop reinforcement 17. The hoop reinforcement 17 comprises a plurality of hoop filamentary reinforcing elements 170 wound circumferentially in a helix so as to extend axially between the axial edge 17A and the other axial edge 17B of the hoop layer 17 in a main direction D1 of each hoop filamentary reinforcing element 170. The main direction D1 forms, with the circumferential direction X of the tyre 10, an angle AF which, as an absolute value, is less than or equal to 10°, preferably less than or equal to 7°, and more preferably less than or equal to 5°. Here, AF=−5°. The hoop reinforcement 17 comprises first and second axial portions 171, 172 that are axially separate from each other so that the first axial portion 171 comprises a first strip 173 wound circumferentially in a helix so as to extend axially continuously from the axial edge 17A of the hoop reinforcement 17 to an axially inner edge 171A of the first axial portion 171, and so that the second axial portion 172 comprises a second strip 174 wound circumferentially in a helix so as to extend axially continuously from an axially inner edge 172B of the second axial portion 172 to the axial edge 17B of the hoop reinforcement 17.

The working layer 18 is delimited axially by two axial edges 18A, 18B of the working layer 18. The working layer 18 comprises working filamentary reinforcing elements 180 extending axially from the axial edge 18A to the other axial edge 18B of the working layer 18 substantially parallel to each other. Each working filamentary reinforcing element 180 extends in a main direction D2 of each working filamentary reinforcing element 180. The direction D2 forms, with the circumferential direction X of the tyre 10, an angle AT which, as an absolute value, is strictly greater than 10°, preferably ranging from 15° to 50°. Here, AT=−35°.

The carcass layer 34 is delimited axially by two axial edges 34A, 34B of the carcass layer 34. The carcass layer 34 comprises carcass filamentary reinforcing elements 340 extending axially from the axial edge 34A to the other axial edge 34B of the carcass layer 34. The carcass layer 34 comprises an axially central portion 34S extending axially in radial line with the working layer 18 and two axially lateral portions 34F extending axially between the axially central portion 34S and each axial edge 34A, 34B. Each axially lateral portion 34F is wound around each circumferential reinforcing element 26. Each axially lateral portion 34F comprises an inner axially lateral portion 38 arranged axially between the axially central portion 34S and each circumferential reinforcing element 26, and an outer axially lateral portion 40 arranged axially between each circumferential reinforcing element 26 and each axial edge 34A, 34B of the carcass layer 34. The filling mass 30 is interposed between the inner and outer axially lateral portions 38, 40.

Each carcass filamentary reinforcing element 340 extends in a main direction D3 of each carcass filamentary reinforcing element 340 that forms, with the circumferential direction X of the tyre 10, an angle ACS which, as an absolute value, is strictly less than 80° in the axially central portion 34S of the carcass layer 34. Advantageously, in this axially central portion 34S of the carcass layer 34, the main direction D3 of each carcass filamentary reinforcing element 340 forms, with the circumferential direction X of the tyre 10, an angle ACS which, as an absolute value, ranges from 50° to 75°. Here, ACS=+65°.

The axially central portion 34S of the carcass layer 34 has an axial width equal to at least 40%, preferably at least 50%, of the axial width L of the working layer 18 and equal to at most 90%, preferably at most 80%, of the axial width L of the working layer 18, and in this particular instance equal to 60% of the working layer 18. The mid-plane M of the tyre 10 intersects this portion 34S. More preferably, this portion 34S is axially centred on the mid-plane M of the tyre 10.

As illustrated in FIGS. 1 and 3, the main direction D3 of each carcass filamentary reinforcing element 340 forms, with the circumferential direction X of the tyre 10, an angle ACF which, as an absolute value, ranges from 80° to 90°, preferably from 85° to 90° and, more preferably, is substantially equal to 90° in each axially lateral portion 34F of the carcass layer 34 that extends radially in each sidewall 22. Here, ACF=+90°.

Each portion 34F of the carcass layer 34 extending radially in each sidewall 22 has a radial height equal to at least 50% of the radial height H of the tyre 10 and equal to at most 100% of the radial height H of the tyre 10, and in this particular instance equal to 95% of the radial height H of the tyre 10. The equatorial circumferential plane E of the tyre 10 intersects each portion 34F of the carcass layer 34 situated in each sidewall 22.

As illustrated in FIG. 2, the main direction D2 of each working filamentary reinforcing element 180 and the main direction D3 of each carcass filamentary reinforcing element 340 form, with the circumferential direction X of the tyre 10, angles AT and ACS with opposite orientations in a portion PS of the tyre 10 located axially between the axial edges 18A, 18B of the working layer 18. Specifically, here, AT=−35° and ACS=+65°. In addition, the main direction D1 of each of hoop filamentary reinforcing element 170, the main direction D2 of each working filamentary reinforcing element 180 and the main direction D3 of each carcass filamentary reinforcing element 340 form, with the circumferential direction X of the tyre 10, paired angles that differ as an absolute value in a portion PS' of the tyre 10 located axially between the axial edges 17A, 17B of the hoop reinforcement 17.

In general and in particular in the embodiment described, each portion PS, PS' of the tyre 10 has an axial width equal to at least 40%, preferably at least 50%, of the axial width L of the working layer 18 and equal to at most 90%, preferably at most 80%, of the axial width L of the working layer 18 and in this particular instance equal to 60% of the axial width L of the working layer 18. The mid-plane M of the tyre 10 intersects each portion PS, PS' of the tyre 10. More preferably, each portion PS, PS' of the tyre 10 is axially centred on the mid-plane M of the tyre 10.

Each working filamentary reinforcing element 180 is an assembly of two steel monofilaments that each have a diameter equal to 0.30 mm, the two steel monofilaments being wound together at a pitch of 14 mm.

Each carcass filamentary reinforcing element 340 conventionally comprises two multifilament strands, each multifilament strand consisting of a spun yarn of polyester monofilaments, here PET, these two multifilament strands being individually over-twisted at 240 turns per meter in one direction and then twisted together at 240 turns per meter in the opposite direction. These two multifilament strands are wound in a helix around each other. Each of these multifilament strands has a thread count equal to 220 tex.

Each hoop filamentary reinforcing element 170 is, for example, of the kind described in WO2016/166056 A1.

With reference to FIG. 1, the tyre 10 comprises an electrically conductive element 80 arranged so as to ensure electrical conductivity between the mounting support when the tyre 10 is mounted on the mounting support, and the crown 12, by means of the conductive element 80. Here, the electrically conductive element 80 comprises first and second axial ends 80A, 80B (only the end 80A is illustrated in FIG. 1) and extends axially from a first of the beads 24 into the second of the beads 24, passing radially between the radially outermost working layer, here the working layer 18, and the hoop reinforcement 17, so that each first and second axial end 80A, 80B is in contact with first and second masses 82 of electrically conductive materials of each first and second bead 24 respectively, each first and second mass 82 of an electrically conductive material being in contact with the mounting support when the tyre 10 is mounted on the mounting support.

Here, the electrically conductive element 80 comprises a layer 84 made up of an electrically conductive material, in this particular instance made up of an elastomeric material based on a composition as described for example in US2005/0103412.

The electrically conductive element 80, here the layer 84, extends radially inside the equatorial circumferential plane E and is radially continuous between any point of the electrically conductive element 80 situated radially inside the equatorial circumferential plane E, and any point of the electrically conductive element 80 situated radially between the working layer 18 and the hoop reinforcement 17. The electrically conductive element 80 takes the form of a ribbon having a width equal to 20 mm.

The crown 12 is arranged so as to ensure electrical conductivity from the electrically conductive element 80 to the tread surface 13 radially through or by means of the hoop reinforcement 17 and by means of the tread 20.

To this end, the electrically conductive element 80 comprises at least one so-called interposed portion 801 that is arranged radially between the working layer 18 and the hoop reinforcement 17.

The hoop reinforcement 17 is arranged so as to prevent electrical conductivity from the interposed portion of the electrically conductive element 80 to the tread 20 by means of the hoop reinforcement 19. In this particular instance, the hoop filamentary reinforcing elements 170 are embedded in an electrically insulating elastomeric material, in this case an elastomeric material based on a composition as described in US20180066128, FR3059598, or U.S. Pat. No. 6,289,958.

The working reinforcement 16 is arranged so as to prevent electrical conductivity by means of the working reinforcement 16. In this particular instance, the filamentary reinforcing elements 180 of the working layer 18 are embedded in an electrically insulating material, in this case a material based on a composition as described in US20180066128, FR3059598, or U.S. Pat. No. 6,289,958.

In addition, the crown 12 comprises the additional mass 86 of an electrically conductive material arranged so as to ensure electrical conductivity from the interposed portion 801 of the electrically conductive element 80 to the tread 20 radially through the hoop reinforcement 17 by means of the additional mass 86 of the electrically conductive material. The additional mass 86 is arranged radially between the tread 20 and the interposed portion 801 of the electrically conductive element 80 and arranged axially between the first and second axial portions 171 and 172 of the hoop reinforcement 17.

In addition to the first and second masses 201 and 202, the tread 20 comprises at least one mass 88 of at least one electrically conductive material. The masses 201, 202 and 88 are arranged so as to ensure electrical conductivity from the additional mass 82 of the electrically conductive material to the tread surface 13 by means of the mass 88 of the electrically conductive material radially through the masses 201, 202 of electrically insulating materials. It will be noted that for reasons of simplification, the masses 86 and 88 are made from the same electrically conductive material.

The tyre 10 is obtained by a method which will be described with reference to FIGS. 4 to 16.

First of all, a working assembly 50 and a carcass assembly 52 are manufactured by arranging the filamentary reinforcing elements 180 and 340 of each assembly 50 and 52 parallel to each other and embedding them, for example by skim coating, in a non-crosslinked composition comprising at least one elastomer, the composition being suitable for forming an elastomer matrix once crosslinked. A ply known as a straight ply, in which the filamentary reinforcing elements are parallel to each other and are parallel to the main direction of the ply, is obtained.

Next, for the working ply, portions of the straight working ply are cut at a cutting angle and these portions are butted against each other so as to obtain a working ply known as an angled working ply, in which the working filamentary reinforcing elements are parallel to each other and form an angle with the main direction of the working ply equal to the cutting angle.

For the carcass ply, portions of the straight carcass ply are cut perpendicularly to the main direction of the straight carcass ply and these portions are butted against each other so as to obtain a carcass ply known as an angled carcass ply, in which the carcass filamentary reinforcing elements are parallel to each other and form an angle ranging from 80° to 90° with the main direction of the carcass ply equal to the cutting angle.

In the embodiment described, a single working ply 49 and a single carcass ply 51 are obtained, the axial width of each of which, that is, the dimension in a direction perpendicular to the longitudinal edges of each ply, is equal to the respective axial width of each working assembly 50 and carcass assembly 52 that will be formed subsequently.

With reference to FIG. 4, in a first step of assembling a green tyre, a sealing ply 70 is arranged around a main support 60 having a substantially cylindrical shape about its main axis A, so as to form a sealing assembly 72 suitable for forming the sealing layer 15. Here, the sealing ply 70 is arranged by winding the sealing ply 70.

Next, with reference to FIG. 5, radially outside the sealing assembly 72, two sidewall reinforcing plies are arranged around the main support 60 so as to form two sidewall reinforcing assemblies 73, followed by the carcass ply 51 so as to form the carcass assembly 52 suitable for forming the carcass layer 34. In this particular instance, each sidewall reinforcing assembly 73 and the carcass assembly 52 are arranged by winding each sidewall reinforcing ply and the carcass ply 51 respectively around the main support 60. Two filling assemblies 74 suitable for forming each filling mass 30 are then arranged radially outside the carcass assembly 52. Next, the two circumferential reinforcing elements 26 are arranged around the carcass assembly 52.

With reference to FIG. 6, each axial edge 52A, 52B of the carcass assembly 52 is turned axially inwards so as to radially cover each circumferential reinforcing element 26 with each axial edge 52A, 52B of the carcass assembly 52 and so that the carcass assembly 52 is wound axially around each circumferential reinforcing element 26.

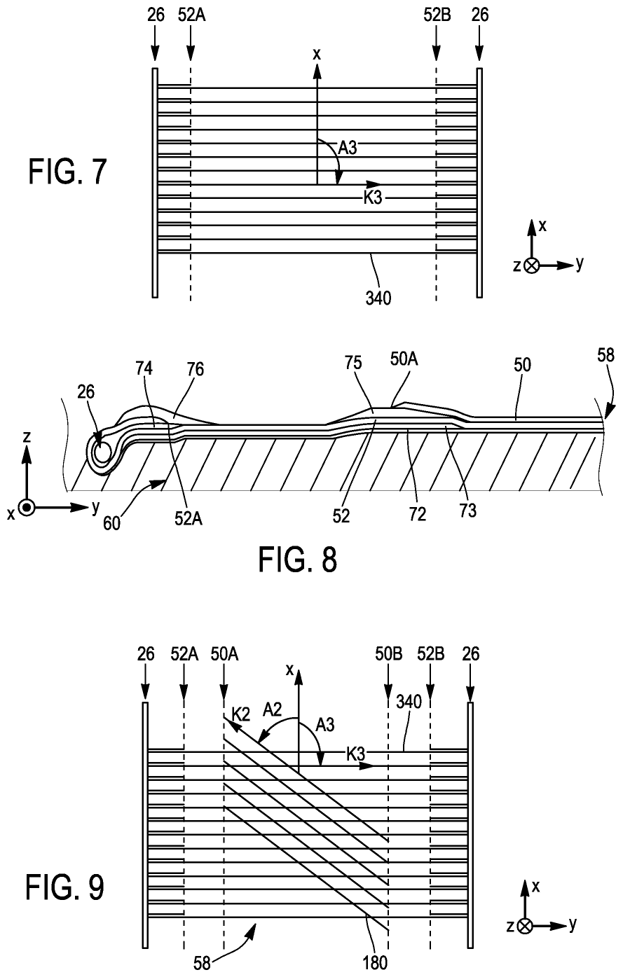

FIG. 7 shows a diagram illustrating the arrangement of the carcass filamentary reinforcing elements 340 following the step of axially turning the axial edges 52A, 52B of the carcass assembly 52 around the circumferential reinforcing elements 26. The carcass assembly 52 is delimited axially by the two axial edges 52A, 52B and comprises the carcass filamentary reinforcing elements 340 extending substantially parallel to each other axially from the axial edge 52A to the other axial edge 52B of the carcass assembly 52. Each carcass filamentary reinforcing element 340 extends, in the carcass assembly 51, in a main direction K3 of each carcass filamentary reinforcing element 340 in the carcass assembly 52. The main direction K3 forms, with the circumferential direction x of the main support 60, an initial angle A3 of each carcass filamentary reinforcing element 340 ranging, as an absolute value, from 80° to 90°, preferably ranging from 85° to 90°, and here substantially equal to 90°. Other angles A3 can be envisaged, such as for example the angles corresponding to the angles A3 described in WO2016166056, WO2016166057, and EP3489035.

Next, with reference to FIG. 8, two assemblies 75 for supporting each end 18A, 18B of the working layer 18 are arranged radially outside the carcass assembly 52. Two intermediate filling assemblies 76 are also arranged radially outside the carcass assembly 52. Next, the working assembly 50 suitable for forming the working layer 18 is arranged radially outside the carcass assembly 52 and each supporting assembly 75. In this particular instance, the working assembly is arranged by winding the working ply 49, radially outside the carcass assembly 52 and each supporting assembly 75, so as to form the working assembly 50. The working assembly 50 is arranged so as to prevent electrical conductivity by means of the working reinforcement 16, once the tyre 10 has been manufactured.

FIG. 9 shows a diagram similar to the one in FIG. 7, illustrating the arrangement of the carcass filamentary reinforcing elements 340 and the working filamentary reinforcing elements 180 following the step of forming the working assembly 50. The working assembly 50 is delimited axially by two axial edges 50A, 50B of the working assembly 50 and comprises the working filamentary reinforcing elements 180 extending substantially parallel to each other axially from the axial edge 50A to the other axial edge 50B of the working assembly 50. Each working filamentary reinforcing element 180 extends, in the working assembly 50, in a main direction K2 of each working filamentary reinforcing element 180 in the working assembly 50. The main direction K2 forms, with the circumferential direction x of the main support 60, an initial angle A2 of each working filamentary reinforcing element 180 which, as an absolute value, ranges from 25° to 50°. Here, A2=−39°.

The carcass assembly 52 and the working assembly 50 then form an assembly 58 with a substantially cylindrical shape about the main axis A of the main support 60.

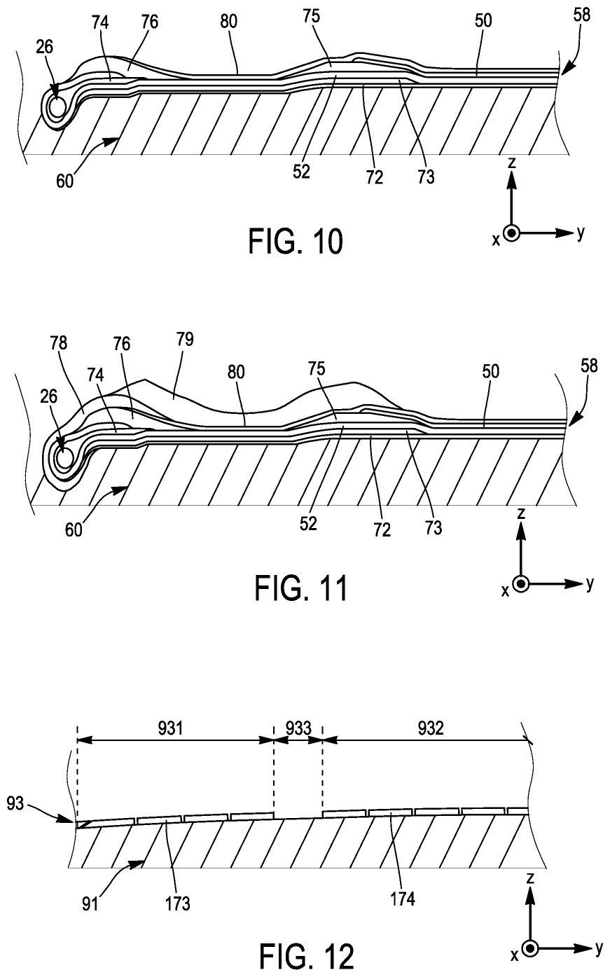

With reference to FIG. 10, the electrically conductive element 80 is arranged radially outside the working assembly 50, each supporting assembly 75, and each intermediate filling assembly 76. In this particular instance, the electrically conductive element 80 is arranged by winding a layer of the electrically conductive material through less than one turn, preferably by winding through less than one tenth of a turn. The electrically conductive element 80 extends axially from one intermediate filling assembly 76 to the other intermediate filling assembly 76 situated on the other side of the mid-plane of the main support 60.

With reference to FIG. 11, two outer bead assemblies 78 each suitable for forming an outer part of each bead 24 are arranged radially outside the electrically conductive element 80 and each intermediate filling assembly 76 and radially inside the sealing assembly 72. Two sidewall assemblies 79 each suitable for forming part of each sidewall 22 are arranged radially outside each outer bead assembly 78 and the electrically conductive element 80.

Independently of the manufacturing of the assembly illustrated in FIGS. 4 to 11, an intermediate assembly 92 the manufacturing steps of which will be described with reference to FIGS. 12 to 14 is formed on an intermediate support 91 having a substantially toric shape about a main axis B of the intermediate support 91. The intermediate assembly 92 comprises a hoop assembly 93 suitable for forming the hoop reinforcement 17, the additional mass 86 of electrically conductive material, and a tread assembly 94 suitable for forming the tread 20.

With reference to FIG. 12, the hoop assembly 93 is arranged so as to ensure electrical conductivity from the interposed portion 801 of the electrically conductive element 80 to the tread 20 radially through the hoop reinforcement 17, once the tyre 10 has been manufactured. In this particular instance, the hoop assembly 93 is arranged so as to form first and second axial portions denoted 931, 932 respectively of the hoop assembly 93 that are axially separate over at least one axial portion 933 of the hoop assembly 93. Each first and second axial portion 931, 932 of the hoop assembly 93 is respectively suitable for forming each first and second axial portion 171 and 172 of the hoop reinforcement 17. Each first and second axial portion 931, 932 of the hoop assembly 93 is formed by respectively winding first and second strips 173, 174 that are separate from each other.

Next, with reference to FIG. 13, the additional mass 86 of electrically conductive material is arranged axially between the first and second axial portions 931, 932 of the hoop assembly 93 so as to ensure electrical conductivity from the interposed portion 801 of the electrically conductive element 80 to the tread 20 radially through the hoop reinforcement 17 by means of the additional mass 86 of the electrically conductive material, once the tyre 10 has been manufactured.

Next, with reference to FIG. 14, the intermediate assembly 92 is formed by arranging a tread assembly 94 suitable for forming the tread 20 radially outside the hoop assembly 93 and the additional mass 86. The tread assembly 94 comprises the masses 201 and 202 of electrically insulating materials and the mass 88 of electrically conductive material.

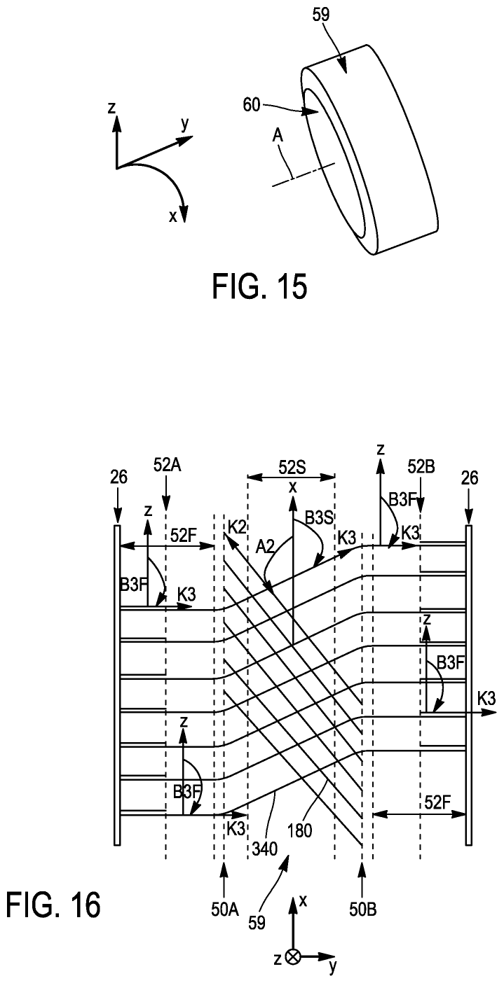

Independently of the manufacturing of the intermediate assembly 92 and with reference to FIG. 15, during a step of deforming the assembly 58, the substantially cylindrical assembly 58 previously manufactured is deformed so as to obtain an assembly 59 having a substantially toric shape about the main axis A of the main support 60.

With reference to FIG. 16, the assembly 58 having a substantially cylindrical shape about the main axis A of the support 60 is deformed so as to obtain the assembly 59 having a substantially toric shape about the main axis A of the main support 60 so that, following the deformation step, the main direction K3 of each carcass filamentary reinforcing element 340 forms, with the circumferential direction x of the main support 60, a final angle B3S of each carcass filamentary reinforcing element 340 which, as an absolute value, is strictly less than 80°, in an axially central portion 52S of the carcass assembly 52 extending axially in radial line with the working assembly 50. Here, B3S=+65°. The portion 52S of the carcass assembly 52 is suitable for forming the axially central portion 34S of the carcass layer 34.

The assembly 58 having a substantially cylindrical shape about the main axis A of the main support 60 is deformed so as to obtain the assembly 59 having a substantially toric shape about the main axis A of the main support 60 also so that, following the deformation step, the main direction K3 of each carcass filamentary reinforcing element 340 forms, with the circumferential direction x of the support 60, a final angle B3F of each carcass filamentary reinforcing element 340, in two axially lateral portions 52F of the carcass assembly 52 each extending axially between the axially central portion 52S and each axial edge 52A, 52B of the carcass assembly 52. Each axially lateral portion 52F of the carcass assembly 52 is suitable for forming each axially lateral portion 34F of the carcass layer 34. Here, B3F=+90°.

The assembly 58 having a substantially cylindrical shape about the main axis A of the main support 60 is deformed so as to obtain the assembly 59 having a substantially toric shape about the main axis A of the support 60 also so that, following the deformation step, the main direction K2 of each working filamentary reinforcing element 340 forms, with the circumferential direction x of the support 60, a final angle B2 of each working filamentary reinforcing element 340 which, as an absolute value, is strictly greater than 10°. Here, B2=−35°.

The final angles B3S, B3F, and B2 are substantially equal to the angles ACS, ACF and AT of the tyre 10.

More generally, the relationships between the angles formed by the carcass and working filamentary reinforcing elements in the method and once the tyre has been manufactured are described in particular in FR2797213 and FR1413102.

Next, during a step of arranging the hoop assembly 93, the hoop assembly 93 is arranged radially outside the assembly 59 having a substantially toric shape about the main axis A of the main support 60. To this end, the intermediate assembly 92 is attached radially outside the assembly 59 having a substantially toric shape about the main axis A of the main support 60 so that the additional mass 86 is arranged radially outside and in contact with the interposed portion 801 of the conductive element 80.

The additional mass 86 is thus arranged radially outside and in contact with the interposed portion 801 of the electrically conductive element 80 after the step of deforming the assembly 58. The tread assembly 94 is arranged so as to ensure electrical conductivity from the interposed portion 801 of the electrically conductive element 80 to the tread surface 13 radially through or by means of the hoop reinforcement 17 and by means of the tread 20, here through the hoop reinforcement by means of the mass 86 and by means of the tread 20 by means of the mass 88, once the tyre 10 has been manufactured.

In the step of arranging the electrically conductive element 80 radially outside the working assembly 50 illustrated in FIG. 10, care is taken to arrange the electrically conductive element 80 so that, after the step of arranging the intermediate element 92 and therefore after the preceding step of arranging the hoop assembly 93, the interposed portion 801 of the electrically conductive element 80 is arranged radially between the working assembly 50 and the hoop assembly 93.

In the manufacturing method described above, care is also taken to arrange the electrically conductive element 80 and the crown 12 so as to ensure electrical conductivity between the mounting support when the tyre 10 is mounted on the mounting support and the crown 12 by means of the electrically conductive element 80, once the tyre 10 has been manufactured.

Finally, the green tyre thus formed is moulded and crosslinked so as to obtain the tyre 10, for example by vulcanization in a mould.

A tyre according to a second embodiment will now be described with reference to FIGS. 17 and 18. Elements similar to those described in the first embodiment are denoted by identical reference signs.

Unlike in the first embodiment, the hoop reinforcement 17 of the tyre 10 according to the second embodiment comprises a single strip 173 wound circumferentially in a helix so that it extends axially continuously from the axial edge 17A to the edge 17B of the hoop reinforcement. During the manufacturing method and as illustrated in FIG. 17, each first and second axial portion 931, 932 of the hoop assembly 93 is formed by continuously winding the single strip 173 and so that the first and second axial portions 931, 932 are axially separate on the axial portion 933 in order to ensure electrical conductivity through the hoop reinforcement 17 once the tyre 10 has been manufactured.

Unlike in the method according to the first embodiment, the tread assembly 94 radially internally holds the additional mass 86 as illustrated in FIG. 18, and the intermediate assembly 92 is formed by arranging the tread assembly 94 suitable for forming the tread 20 and the additional mass 86 radially outside the hoop assembly 93.

A tyre according to a third embodiment will now be described with reference to FIG. 19. Elements similar to those described in the preceding embodiments are denoted by identical reference signs.

Unlike in the preceding embodiments, the masses 201, 202 of the tread 20 are masses of electrically conductive materials. Each mass 201, 202 of electrically conductive material is arranged so as to ensure electrical conductivity from the additional mass 80 of electrically conductive material to the tread surface 13 by means of the or each mass 201, 202. The tread 20 therefore does not comprise a mass 88 of electrically conductive material, as it is unnecessary for ensuring electrical conductivity through the tread 20.

A tyre according to a fourth embodiment will now be described with reference to FIG. 20. Elements similar to those described in the preceding embodiments are denoted by identical reference signs.

Unlike in the first embodiment, the hoop reinforcement 17 of the tyre 10 according to the third embodiment is arranged so as to ensure electrical conductivity from the interposed portion 801 of the electrically conductive element 80 to the tread 20 by means of the hoop reinforcement 17. In this particular instance, the hoop filamentary reinforcing elements 170 are embedded in an electrically conductive material. Such an electrically conductive material is for example identical to the material of the masses 86, 88 of the tyre in the first embodiment.

Similarly to the first embodiment, the tread comprises the masses 201, 202 of electrically insulating materials and the mass 88 of electrically conductive material arranged so as to ensure electrical conductivity from the hoop reinforcement 17 to the tread surface 13 by means of the mass 88 of the electrically conductive material radially through the masses 201, 202 of electrically insulating materials.

The method for manufacturing the tyre 10 according to the third embodiment is such that the hoop assembly 93 is arranged radially outside and in contact with the electrically conductive element 80 so as to ensure electrical conductivity from the interposed portion 801 of the electrically conductive element 80 to the tread 20 by means of the hoop reinforcement 17, once the tyre 10 has been manufactured.

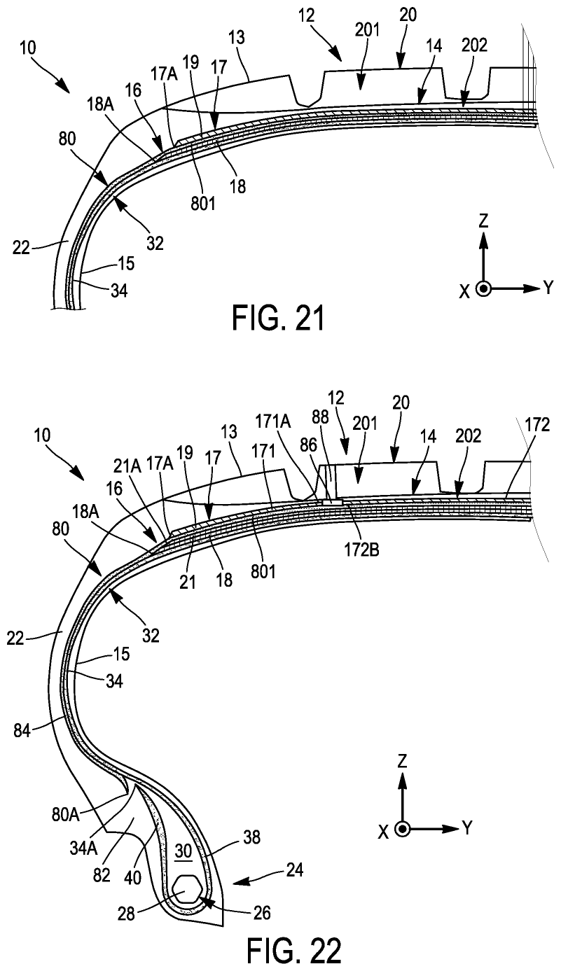

A tyre according to a fifth embodiment will now be described with reference to FIG. 21. Elements similar to those described in the preceding embodiments are denoted by identical reference signs.

Unlike in the tyre according to the fourth embodiment, each mass 201, 202 is arranged so as to ensure electrical conductivity from the hoop reinforcement 17 to the tread surface 13 by means of each mass 201, 202. In this particular instance, each mass 201, 202 is made from an electrically conductive material identical to the one in the third embodiment.

A tyre according to a sixth embodiment will now be described with reference to FIG. 22. Elements similar to those described in the preceding embodiments are denoted by identical reference signs.

The tyre 10 according to the sixth embodiment is such that the working reinforcement 16 comprises a radially innermost working layer 18 and a radially outermost working layer 21 arranged radially outside the radially innermost working layer 18. The radially outermost layer 21 is delimited axially by two axial edges 21A, 21B. The radially outermost working layer 21 comprises working filamentary reinforcing elements 210 extending axially from the axial edge 21A to the other axial edge 21B of the working layer 21 substantially parallel to each other. Each working filamentary reinforcing element 210 extends in a main direction D2′ of each working filamentary reinforcing element 210. The direction D2′ forms, with the circumferential direction X of the tyre 10, an angle AT′ which, as an absolute value, is strictly greater than 10°, preferably ranging from 15° to 50°. Here, AT′=+26°. Unlike in the first embodiment, the angle AT of the working filamentary reinforcing elements 180 is such that AT=−26°.

In addition, unlike in the first embodiment, each carcass filamentary reinforcing element 340 extends in a main direction D3 of each carcass filamentary reinforcing element 340 forming, with the circumferential direction X of the tyre 10, a substantially constant angle AC which, as an absolute value, ranges from 80° to 90° between each axial edge 34A, 34B. Here, as an absolute value, AC is substantially equal to 90°.

The invention is not limited to the embodiments described above.

Specifically, a tyre similar to those described above can easily be envisaged, in which the carcass reinforcement comprises two carcass layers. In this case, according to the invention, the interposed portion is arranged between the radially outermost working layer of the working reinforcement and the hoop reinforcement.

The invention can also be implemented without the carcass layer comprising an axially lateral portion wound around each circumferential reinforcing element 26. Specifically, other ways of anchoring the carcass layer 34 are possible, for example as described in U.S. Pat. No. 5,702,548.

An embodiment similar to the first embodiment can likewise be envisaged, in which each first and second axial end 80A, 80B is in contact with the mounting support when the tyre 10 is mounted on the mounting support.

An embodiment can also be envisaged in which, unlike in the first embodiment, the electrically conductive element 80 extends axially from a first of the beads 24 to radially between the radially outermost working layer 18 and the hoop reinforcement 17 so that the first axial end 80A is in contact with the mass 82 of electrically conductive material and the second axial end 80B is arranged radially between the radially outermost working layer 18 and the hoop reinforcement 17. As a variant, it can be envisaged that the first axial end 80A is in contact with the mounting support when the tyre 10 is mounted on the mounting support, and the second axial end 80B is arranged radially between the radially outermost working layer 18 and the hoop reinforcement 17.

1.-14. (canceled)

15. A tire (10) suitable for being mounted on a mounting support comprises:
a crown (12) comprising a tread (20), comprising a tread surface (13) suitable for coming into contact with a ground being driven on, and a crown reinforcement (14);
two beads (24);
two sidewalls (22) each connecting each bead (24) to the crown (12);
a carcass reinforcement (32) anchored in each bead (24), the carcass reinforcement (32) extending in each sidewall (22) and in the crown (12) radially inside the crown reinforcement (14), and the crown reinforcement (14) being arranged radially between the tread (20) and the carcass reinforcement (32);
a working reinforcement (16) comprising at least one radially outermost working layer (18) of the working reinforcement (16);
a hoop reinforcement (17) arranged radially outside the working reinforcement (16); and
an electrically conductive element (80) arranged so as to ensure electrical conductivity between a mounting support when the tire (10) is mounted on the mounting support and the crown (12) by means of the conductive element (80),
wherein the crown (12) is arranged so as to ensure electrical conductivity from the electrically conductive element (80) to the tread surface (13) radially through or by means of the hoop reinforcement (17) and by means of the tread (20),
wherein at least one interposed portion (801) of the electrically conductive element (80) is arranged radially between the radially outermost working layer (18) of the working reinforcement (16) and the hoop reinforcement (17), and
wherein, as the electrically conductive element (80) extends radially inside an equatorial circumferential plane (E) of the tire (10), the electrically conductive element (80) is radially continuous between:
any point of the electrically conductive element (80) situated radially inside the equatorial circumferential plane (E) of the tire (10), and
any point of the electrically conductive element (80) situated radially between the radially outermost working layer (18) of the working reinforcement (16) and the hoop reinforcement (17).

16. The tire (10) according to claim 15, wherein the working reinforcement (16) is arranged so as to prevent electrical conductivity by means of the working reinforcement (16).

17. The tire (10) according to claim 16, wherein the or each working layer (18) comprises working filamentary reinforcing elements (180) embedded in an electrically insulating material.

18. The tire (10) according to claim 15, wherein the hoop reinforcement (17) is arranged so as to ensure electrical conductivity from the at least one interposed portion (801) of the electrically conductive element (80) to the tread (20) by means of the hoop reinforcement (17).

19. The tire (10) according to claim 18, wherein the hoop reinforcement (17) comprises one or more hoop filamentary reinforcing elements (170) embedded in an electrically conductive material.

20. The tire (10) according to claim 18, wherein the tread (20) comprises one or more masses of one or more electrically conductive materials, the or each mass of the electrically conductive materials being arranged so as to ensure electrical conductivity from the hoop reinforcement (17) to the tread surface (13) by means of the or each mass.

21. The tire (10) according to claim 18, wherein the tread (20) comprises one or more masses of one or more electrically insulating materials and at least one mass (88) of at least one electrically conductive material arranged so as to ensure electrical conductivity from the hoop reinforcement (17) to the tread surface (13) by means of the at least one mass of the electrically conductive material radially through the or each mass of the electrically insulating materials.

22. The tire (10) according to claim 15, wherein the hoop reinforcement (17) is arranged so as to prevent electrical conductivity from the at least one interposed portion (801) of the electrically conductive element (80) to the tread (20) by means of the hoop reinforcement (17).

23. The tire (10) according to claim 22, wherein the hoop reinforcement (17) comprises one or more hoop filamentary reinforcing elements (170) embedded in an electrically insulating elastomeric material.

24. The tire (10) according to claim 22, wherein the crown (12) comprises an additional mass (86) of an electrically conductive material arranged so as to ensure electrical conductivity from the at least one interposed portion (801) of the electrically conductive element (80) to the tread (20) radially through the hoop reinforcement (17) by means of the additional mass (86) of the electrically conductive material.

25. The tire (10) according to claim 24, wherein the additional mass (86) is arranged radially between the tread (20) and the at least one interposed portion (801) of the electrically conductive element (80) and arranged axially between first and second axial portions (171, 172) of the hoop reinforcement (17).

26. The tire (10) according to claim 24, wherein the tread (20) comprises one or more masses of one or more electrically conductive materials, the or each mass of electrically conductive material being arranged so as to ensure electrical conductivity from the additional mass (86) of electrically conductive material to the tread surface (13) by means of the or each mass.

27. The tire (10) according to claim 24, wherein the tread (20) comprises one or more masses of one or more electrically insulating materials and at least one mass (88) of at least one electrically conductive material arranged so as to ensure electrical conductivity from the additional mass (86) of the electrically conductive material to the tread surface (13) by means of the mass (88) of the electrically conductive material radially through the or each mass of the electrically insulating materials.

28. The tire (10) according to claim 15, wherein the electrically conductive element (80) comprises a layer (84) made up of an electrically conductive material.
